(19) United States
(12) Patent Application Publication
(10) Pub. No.: US 2009/0099856 A1
(43) Pub. Date: Apr. 16, 2009

(54) Method for Providing Enhanced Valuation Protection for Shipping of Household Goods by a Motor Carrier

(76) Inventors: Gale D. Preston, Fenton, MO (US); William C. Bachmann, Eureka, MO (US); Eric E. Shutek, Des Peres, MO (US); Timothy M. Baer, Ballwin, MO (US); Jan Alonzo, St. Louis, MO (US); Patrick J. Larch, JR., Sunset Hills, MO (US); James G. Powers, St. Louis, MO (US); Linda Bauer, St. Louis, MO (US); John Lograsso, St. Louis, MO (US); Casey P. Ellis, Waterloo, IL (US)

Correspondence Address: THOMPSON COBURN LLP, ONE US BANK PLAZA, SUITE 3500, ST LOUIS, MO, 63101, US

(21) Appl. No.: 11/870,687

(22) Filed: Oct. 11, 2007

(51) Int. Cl. G06Q 10/00

(52) U.S. Cl. 705/1

(57) ABSTRACT

A method for enhancing the valuation protection available to a shipper for a shipment of household goods whereby the carrier offers for financial consideration to waive one or more common law defenses and/or one or more interpretation limit defenses otherwise available to it to mitigate its liability to a shipper for a claim for damaged/lost goods, and an agreement by the carrier to increase its maximum liability by providing the shipper an additional dollar amount, preferably $25,000, of Full Value Protection coverage in addition to the minimums required by the carrier's tariffs, or in addition to the shipper's Full Value Protection valuation declaration. The financial consideration to be paid by a shipper is at least partially determined by the nature and number of defenses offered to be waived. As one or more common law or interpretation limit defenses may exhibit geographical significance, the offerings may include differential pricing for one or more such common law defenses to be waived. Preferably, and for maximum shifting of the risk of loss/damage from the shipper to the carrier, the enhanced valuation protection includes offering a waiver of all common law defenses.

### TECHNICAL FIELD OF THE INVENTION

The present invention relates to the loss protection covering the shipment of goods by a motor carrier, and even more preferably an improved method of providing enhanced valuation protection for goods being shipped through commerce.

### BACKGROUND OF THE INVENTION

Motor carriers transport goods all across the United States. Shippers, including individuals and families, use motor carriers to transport their personal effects and property to be used in a dwelling (“HHG”) between two points which may be residences; intra-city, interstate and even international between the US and Canada. During transportation, despite the best of care taken by motor carriers, it is not uncommon that sometimes goods are unintentionally damaged or lost during interstate transport. Under federal law, specifically 49 U.S.C. § 14706, a carrier is liable for the actual loss or injury to property including HHG occurring during interstate transport, subject to certain common law and interpretive defenses often incorporated into a Bill of Lading or other contract. Regarding the shipment of household goods, a carrier is liable for “an amount equal to the replacement value of such goods, subject to a maximum amount equal to the declared value of the shipment and to rules issued by the Surface Transportation Board and/or applicable tariffs.” See 49 U.S.C. § 14706(f)(2).

A Bill of Lading is a contract between a carrier (motor carrier) and a shipper for the transportation of goods that includes a description and declared value for the goods. Bills of Lading are typically used and govern the shipment of HHG. When the shipper of HHG declares a value for the goods on the Bill of Lading (the “declared value”), a carrier's liability is ordinarily limited to this declared amount. If any of the HHG are damaged or lost during transport, then the carrier typically has the option to repair the item, replace the item, or make a payment for either the cost of a repair or a replacement. This option of valuation protection is referred to in the industry as Full Value Protection. Should the shipment result in damaged or lost goods, then the shipper is generally entitled to recover up to the declared value of the loss or damage to the goods in question presuming the shipper can meet the burden of proving the damage/loss. A HHG carrier collects a charge for Full Value Protection and this cost is typically based on the amount of Full Value Protection and the deductible amount chosen.

In the case of a household goods shipment, under the terms of a released rates order issued by the Surface Transportation Board (Amendment No. 4 to Released Rates Decision No. MC-999 served Dec. 21, 2001), in order to acquire Full Value Protection from a carrier, the shipper must declare a value for their shipment that meets or exceeds a minimum value declaration per pound times the weight of the shipment (the Household Goods Bureau Committee increased the minimum Full Value Protection amount from $4.00 to $4.90 in Tariff 400-N, Item 3, effective Jan. 1, 2007). For example, a shipper moving a 10,000-pound interstate HHG shipment that wanted to acquire Full Value Protection from a carrier would be required to declare a minimum of $49,000 Full Value Protection ($4.90×10,000-pound shipment=$49,000) and pay an additional corresponding tariff charge to the carrier based upon a schedule of charges in the carrier's tariffs.

Some carriers' tariffs provide for a higher minimum value declaration required by shippers if they want Full Value Protection. As of the time of the filing of this Application, the highest tariff level minimum value declaration required to get Full Value Protection is $6.00 per pound times the weight of the shipment. A shipper can choose to purchase Full Value Protection in an amount in excess of the required minimum value declaration in exchange for payment of the appropriate tariff charge. Once this declared value choice is made by the shipper, this valuation amount declared on the Bill of Lading by the shipper sets a contractual cap or maximum on the amount of damages that the shipper can recover from the carrier in the event of loss or damage, assuming that the shipper can meet their burden of proving the damage/loss under applicable federal law, and no other common law or interpretive defenses apply to the claim.

As an alternative to paying for Full Value Protection, a shipper is ordinarily offered the option of waiving the HHG carrier's liability for Full Value Protection. In that event, the HHG carrier is liable for damages only to the extent provided for in the Surface Transportation Board Released Rates Order. For example, for household goods shipments, under the Released Rate Order in effect as this is being written, the carrier's liability is limited to 60 cents per pound per article if a shipper chooses to waive their right to Full Value Protection. This option of valuation protection is referred to as Released Value. Released Value offers very minimal protection to a shipper because goods are usually worth far more than 60 cents multiplied by their weight in pounds. For example, if a shipper chose to waive their right to Full Value Protection and instead release their shipment at 60 cents per pound per article and if a 10 pound computer valued at $500 were lost or destroyed, the carrier's liability would be limited to 10 pounds×60 cents=$6.00.

There are potential exceptions in coverage that are common to both Full Value Protection and Released Value, and these may be generally classified into two categories. One such category may be described as “Interpretation Limits” and the other as “Common Law Defenses” As an example of an Interpretation Limits exception, one can consider the situation of damage to a component of a set or pair. For example, if a carrier damages one chair from a dining room set and cannot acceptably repair or replace the chair, some carriers have made the interpretation that under the controlling law and regulations it is only liable for the repair or replacement value of the single damaged chair under Full Value Protection or 60 cents multiplied by its weight in pounds under Released Value. Because this carrier presumes it has no liability for the undamaged goods comprising the remainder of the set, a shipper is then left with the option of owning a dining room set with an inferiority repaired chair, a mismatched set, or purchasing a new set for a cost greatly in excess of the amount paid by the carrier. Some carriers have taken a different interpretation of their liability for “pairs or sets” where the carrier will either replace or pay an amount equal to the whole set if it can't make an acceptable repair or find an exact replacement for a damaged part of the set. Yet another example of an “interpretation limit” is what may be referred to “mechanical derangement”. An example of mechanical derangement is a stereo or television that the carrier moves, but after transportation and upon arrival at destination it fails to work properly, or at all. Under Full Value Protection, the stereo or television would not be eligible for compensation for failing to work assuming there was no objective evidence to verify that the carrier damaged the stereo or television while in transit.

Even if the shipper purchases Full Value Protection or Released Value, a carrier's liability is also limited by Common Law Defenses including, but not limited to, that the goods were damaged by (a) an act of God, (b) Force Majeure, (c) inherent vice or nature of the goods, (d) an act of the shipper, (e) public authority, and (f) public enemy which could be extended to include terrorist activity. An act of God is generally considered to be a natural phenomena such as lightning, storms, floods, and earthquakes. For example, a carrier might not be liable for goods damaged by a landslide which washed a household goods moving van off a road. Inherent vice includes any existing defects, diseases, decay or the inherent nature of the good which will cause it to deteriorate over time. As an example, a carrier would not be liable for mild rust on a metal item, such as a chair, created by atmospheric conditions but first discovered after a move.

An example of an act by the shipper that eliminates carrier liability is improper packaging. If a shipper fails to properly pack a good and it is damaged during transport, the carrier would not be liable if this defect was not discoverable through ordinary observation by the carrier. A carrier is also not generally held to be liable for damages from acts by public authority such as prevention of delivery by the government, embargoes, or loss of cargo through the legal process and declaration of martial law. A carrier is exempt from damages caused by a public enemy such as military forces of a nation at war with the United States. As can be seen from this non-exhaustive list of examples, there are numerous instances where a carrier is not liable for damages to HHG, whether the shipper opts for Full Value Protection or Released Value.

Moving into a new home is a very stressful time for a household. Whether the property moved is household goods, family heirlooms, expensive furniture, or inexpensive items with sentimental value, it is important to their owner that everything arrives at the new home safely. While carriers do their best to deliver all of the goods undamaged, some loss or damages are inevitable. As can be seen from the discussion above, when goods are lost or damaged during transit, there are instances where a shipper will not be eligible to be completely compensated under the Released Value option or under the Full Value Protection option.

Yet another factor to consider is the challenge of a shipper to not only meet his burden to prove up his claim, but also the need to work through the process of making the claim, obtaining reimbursement, and then finding and buying the replacement goods, or getting damaged items repaired. Again, a shipper of HHG is generally occupied with other more pressing concerns when moving and adding this issue to his list can be overwhelming. This unfortunately often results in unhappy shippers which can affect the future business of the carrier, and increased administrative burden for the carrier in appropriately processing these eventual claims.

Thus there is a need for a method to enhance the valuation protection for cargo loss or damage that will alleviate some of these burdens and risk to a shipper for damaged/lost goods and reduce the administrative burden for the carrier, which at the same time would also help produce a better experience for the shipper, thus increasing the likelihood for repeat business as well as a better reputation. Should such a method be developed, it is also likely that if appropriately explained to shippers they would be willing to pay extra for it, thus increasing the carrier's revenue opportunities.

### SUMMARY OF THE INVENTION

In accordance with the principles of the preferred embodiment of this invention, a method of providing enhanced Full Value Protection valuation protection for the shipment of HHG preferably comprises offering to the shipper, for a contractually agreed upon price, an agreement by the carrier to waive one or more Common Law Defenses and/or Interpretation Limits to its liability for lost or damaged goods to thereby shift the risk of damage/loss to the carrier for the shipment, and an agreement by the carrier to increase its maximum liability by providing the shipper an additional dollar amount, such as preferably $25,000, of Full Value Protection coverage in addition to the minimums required by the carrier's tariffs or an additional amount declared by the shipper if the amount declared exceeds the minimums required by the carrier's tariffs. For example, if the minimum value declaration required to get Full Value Protection is $6.00 per pound times the weight of the shipment, and if the additional dollar amount of Full Value Protection coverage was designated as $25,000, a shipper moving a 10,000 pound shipment that wanted to acquire Full Value Protection from a UniGroup (the assignee of the present invention) carrier would have a total of $85,000 Full Value Protection if they purchased this enhanced valuation product ($6.00×10,000-pound shipment=$60,000 Full Value Protection+$25,000 additional Full Value Protection=$85,000).

In the preferred embodiment of this invention, this may be coupled with Full Value Protection and replacement of pairs or sets so that a shipper of household goods can enjoy the greatest likelihood that he/she will be compensated up to the declared level of valuation coverage in the event that one of his/her goods is damaged/lost during a move.

In accordance with one aspect of the invention, the method of enhanced valuation protection preferably includes offering an agreement, typically through a written contract, by the carrier for a fee to waive its defense to a shipper claim that damage/loss to a good was caused by one or more of the Common Law Defenses, such as an Act of God, inherent vice, an act of the shipper, public authority, and public enemy.

In another aspect of the invention, the method of enhanced valuation protection preferably includes offering an agreement, typically through a written contract, by the carrier for a fee to waive its defense to a shipper claim that damage/loss to a good was caused by one or more of the Interpretation Limits, such as pairs and sets, mechanical derangement, etc.

In another aspect of the invention, the method of enhanced valuation protection preferably includes offering an agreement, typically through a written contract, by the carrier to add an additional dollar amount of Full Value Protection coverage in addition to the minimums required by the carrier's tariffs, or in addition to the shipper's Full Value Protection valuation declaration if it exceeds the minimums required in the carrier's tariffs.

In another aspect of the invention, the method of enhanced valuation protection preferably includes offering differential pricing depending on the type and number of Common Law Defenses or Interpretation Limits elected by the shipper to be waived by the carrier, and the agreement by the carrier to add an additional dollar amount of Full Value Protection coverage in addition to the minimums required by the carrier's tariffs, or in addition to the shipper's Full Valuation Protection valuation declaration if it exceeds the minimums required in the carrier's tariffs.

### DRAWINGS

It is not deemed to be necessary, or meaningful to achieving an understanding of the invention, for drawings to be provided and hence none are included herein.

### DETAILED DESCRIPTION OF THE PREFERRED EMBODIMENT

In the following detailed description, numerous specific details are set forth in order to provide a thorough understanding of the inventors' best mode of the invention to one of ordinary skill in the art and to enable that skilled artisan to practice the invention for its intended purposes. However, it will be understood by those skilled in the art that the present invention may be practiced without these specific details. Instead, well-known methods and procedures may be used with the present disclosure as a guide to produce other embodiments of the invention, by those of skill in the art, and all of those embodiments are to be considered as included within the scope of this invention.

In the preferred embodiment of the present invention a carrier offers an enhanced valuation protection involving Full Value Protection by adding an additional dollar amount of Full Value Protection coverage in addition to the minimums required by the carrier's tariffs, or in addition to the shipper's Full Value Protection valuation declaration if it exceeds the minimum required in the carrier's tariffs, replacement of pairs or sets, and an agreement by the carrier to waive at least one of its Common Law Defenses to its liability for lost or damaged goods.

As discussed in the background section, Full Value Protection is well known in the art and the carrier is liable for up to the total amount declared by the shipper on the Bill of Lading for which the shipper can meet his/her burden of proof of loss/damage. Typically, the declared value is a lump sum, and the amount of compensation paid to a shipper for loss or damage is based on the shipper's ability to meet their burden of proof and prove their loss/damage.

The replacement of pairs or sets of goods when only one component is damaged is also known in the art. For example, if one of a pair of lamps is damaged and cannot be repaired or replaced with an identical lamp, the carrier will replace both lamps depending on that carrier's interpretation of the law and regulations. Other examples of sets that might need replacement when only one component is damaged or lost include china, silver flatware, crystal, and dining room sets. However, many carriers do not pay for loss or damage to pairs and sets, as a matter of interpretation.

Even should the carrier pay for loss or damage to pairs and sets, the shipper still might not be compensated because of a carrier's Common Law Defenses to liability for lost or damaged goods. A carrier's Common Law Defenses are presently understood to include that the goods were damaged/lost by (a) an act of God, (b) Force Majeure, (c) inherent vice or nature of the goods, (d) an act of the shipper, (e) public authority, and (f) public enemy which could be extended to include terrorist activity. These Common Law Defenses are available despite the fact that a shipper has opted for the “best” valuation option offered to him under present carrier practices. The same Common Law Defenses would be anticipated to be available to a carrier even should other more enhanced valuation coverages be offered to a shipper.

It is also to be noted that the common law is ever evolving. In other words, it is not impossible for a court in some future lawsuit to decide to add another new common law defense, change the availability or scope of an existing common law defense, or create exceptions to what might otherwise be anticipated to be subject to any such defense. Thus, a shipper who relies solely on existing valuation coverages is susceptible to the risks created by the very nature of the common law.

In accordance with the present invention, and its preferred embodiment, a carrier would be offering a covenant, or contractual obligation, to waive one or more and even maybe all of its Common Law defenses to a shipper claim for damaged/lost goods. By agreeing to waive every one of these Common Law Defenses, perhaps even those known to exist now or which may come into being, a carrier can offer an enhanced valuation protection to the shipper. This inventive method for the first time known to the inventors herein can be used to selectively and even entirely shift the risk of these defenses from the shipper to the carrier.

In accordance with the present invention, and its preferred embodiment, a carrier would be offering a covenant, or contractual obligation, to waive one or more and even maybe all Interpretation Limit defenses to a shipper claim for damaged/lost goods.

In accordance with the present invention, and its preferred embodiment, a carrier would be offering a covenant, or contractual obligation, to increase the Full Value Protection amount declared by the shipper by an additional dollar amount of Full Value Protection coverage in addition to the minimums required by the carrier's tariffs, or in addition to the shipper's Full Value Protection valuation declaration if it exceeds the minimums required by the carrier's tariffs.

Yet another important aspect to this present invention is that this creates a revenue opportunity in a competitive market, and an opportunity for which a shipper can readily perceive value and would be very likely to buy. As the benefit would be provided through a carrier's contractual obligation, and would not necessarily require any adjustment to the methods previously used by the carrier to mitigate for these losses, if priced appropriately, it offers a profit opportunity in a mature and regulated business which provides a significant commercial advantage.

The number and kind of waiver offerings may be tailored to specific geographical regions of the country to address risks of greater concern for those areas. For example, risk of damage/loss due to storm/flooding may be more desirably shifted to the carrier in the Gulf coast states and along the Eastern seaboard. Risks related to heat may be perceived as more important to address in the Southwest in the summer. Other similar kinds of special offerings may be conveniently carved out and priced appropriately to suit the business purposes of the carrier and needs of the shipper.

Most preferably, the inventors believe that the typical shipper of HHG would find most appealing being able to secure an additional dollar value, such as preferably $25,000, of Full Value Protection coverage and a waiver of Common Law Defenses other than shipper's acts, inherent vice, and Force Majeure, coupled with a waiver of Interpretation Limits of pairs and sets and mechanical derangement; however, the method has not been commercially implemented as of this writing and is expected to be further considered before introduction.

The foregoing description has been given as merely illustrative of the invention and should not be considered as limiting the invention in any way. Instead, the invention should be considered as including any variations and changes as would be apparent to those of skill in the art, relying on and following the teachings contained herein. The invention is intended by the inventors to be limited only by scope of the claims appended hereto, and their legal equivalents.

What is claimed is:

1. A method for a motor carrier of HHG to enhance the valuation protection for a shipment of HHG comprising offering an agreement by the motor carrier providing transport of HHG for a shipper, the agreement comprising a waiver of at least one common law defense to the shipper's potential claim for carrier liability for HHG damaged/lost during transport.

2. The method of claim 1 wherein the waiver of at least one common law defense comprises a common law defense that the damage/loss to the good was caused by an act of God.

3. The method of claim 1 wherein the waiver of at least one common law defense comprises the common law defense that the damage/loss to the good was caused by inherent vice.

4. The method of claim 1 wherein the waiver of at least one common law defense comprises the common law defense that the damage/loss to the good was caused by an act of the shipper.

5. The method of claim 1 wherein the waiver of at least one common law defense comprises the common law defense that the damage/loss to the good was caused by an act of public authority.

6. The method of claim 1 wherein the waiver of at least one common law defense comprises the common law defense that the damage/loss to the good was caused by an act of a public enemy.

7. The method of claim 1 wherein the waiver of at least one common law defense comprises all common law defenses to the carrier in the event of a shipper claim.

8. The method of claim 1 wherein there are a plurality of common law defenses of varying kind and the method further comprising pricing the valuation protection to the shipper corresponding to the number and kind of the common law defenses offered to be waived.

9. The method of claim 1 wherein the waiver of all common law defenses comprises waiving all common law defenses to the carrier in existence at any time, either before or after the damage/loss, in the event of a shipper claim.

10. The method of claim 1 wherein the plurality of common law defenses comprises defenses having relative geographic significance, and wherein the financial consideration comprises differential pricing based on the relative geographic significance.

11. The method of claim 1 wherein offering includes offering to waive one or more common law defenses for selective acceptance by the shipper.

12. A method for a motor carrier of HHG to enhance the valuation protection for a shipment of HHG comprising offering an agreement by the motor carrier providing transport of HHG for a shipper, the agreement comprising a waiver of at least one interpretation limit defense to the shipper's potential claim for carrier liability for HHG damaged/lost during transport.

13. The method of claim 12 wherein the waiver of at least one interpretation limit defense comprises that the damage/loss to the good was part of a pair or set.

14. The method of claim 12 wherein the waiver of at least one interpretation limit defense comprises the interpretation limit defense of mechanical derangement.

15. The method of claim 12 wherein the waiver of at least one interpretation limit defense comprises all interpretation limit defenses to the carrier in existence at any time, either before or after the damage/loss, in the event of a shipper claim.

16. The method of claim 12 wherein there are a plurality of interpretation limit defenses of varying kind and the method further comprising pricing the valuation protection to the shipper corresponding to the number and kind of the interpretation limit defenses offered to be waived.

17. A method for a motor carrier of HHG to enhance the valuation protection for a shipment of HHG comprising offering for financial consideration a contractual obligation by the motor carrier providing transport of HHG for a shipper, the contractual obligation comprising a waiver of all common law and interpretation limit defenses to the shipper's potential claim for carrier liability for HHG damaged/lost during transport.

18. The method of claim 17 wherein the waiver of all common law defenses comprises waiving all common law defenses to the carrier in existence at any time, either before or after the damage/loss, in the event of a shipper claim.

19. The method of claim 17 wherein the waiver of all interpretation limit defenses comprises waiving all interpretation limit defenses as they exist in the law at a predetermined time.

20. The method of claim 17 wherein the plurality of common law defenses do not include shippers acts, inherent vice and force majeure.

21. The method of claim 17 wherein offering includes offering to waive one or more interpretation limit defenses for selective acceptance by the shipper.

22. The method of claim 17 wherein the agreement further comprises the motor carrier's agreement to provide an additional dollar amount of Full Value Protection coverage in addition to the minimums required by the carrier's tariffs.

23. The method of claim 17 wherein the agreement further comprises the motor carrier's agreement to provide an additional dollar amount of Full Value Protection coverage in addition to the shipper's Full Value Protection valuation declaration.

24. A method for a motor carrier to enhance the valuation protection for a shipment of HHG comprising offering an agreement by the motor carrier providing transport of HHG for a shipper, the agreement comprising the motor carrier's agreement to provide an increased monetary value of Full Value Protection coverage in addition to the minimum amounts of Full Value Protection that a shipper is required to declare in order to meet the motor carrier's tariffs.
